(19) United States
(12) Patent Application Publication
(10) Pub. No.: US 2025/0029131 A1
(43) Pub. Date: Jan. 23, 2025

(54) INFORMATION PROCESSING DEVICE

(71) Applicant: Toyota Jidosha Kabushiki Kaisha, Toyota-shi (JP)

(72) Inventors: Shigeki MATSUMOTO, Nagoya-shi (JP); Naoya Oka, Nagakute-shi (JP); Hidetaka Eguchi, Nagoya-shi (JP); Shigeru Ichikawa, Nagoya-shi (JP); Takeshi Yamada, Nagoya-shi (JP); Masayo Nagai, Nagoya-shi (JP); Ryosuke Yamamoto, Konan-shi (JP)

(73) Assignee: Toyota Jidosha Kabushiki Kaisha, Toyota-shi (JP)

(21) Appl. No.: 18/670,127

(22) Filed: May 21, 2024

(30) Foreign Application Priority Data
Jul. 21, 2023 (JP) 2023-118930

(51) Int. Cl. G06Q 30/0207; G06F 21/60

(52) U.S. Cl. CPC G06Q 30/0207; G06F 21/60

(57) ABSTRACT

A first consent to utilizing first data collected from a first vehicle for a first purpose is obtained from a user of the first vehicle, a second consent to diverting the first data collected based on the first consent to a second purpose is obtained from a user of the first vehicle, and a predetermined process is performed to give a user of the first vehicle a portion of the benefit generated by diverting the first data to the second purpose.

### CROSS-REFERENCE TO RELATED APPLICATION

This application claims priority to Japanese Patent Application No. 2023-118930 filed on Jul. 21, 2023, incorporated herein by reference in its entirety.

### BACKGROUND

### 1. Technical Field

The present disclosure relates to a technique for collecting information from a vehicle.

### 2. Description of Related Art

In recent years, there has been a demand for proper management of personal information. In this regard, Japanese Unexamined Patent Application Publication No. 2017-228255 (JP 2017-228255 A), for example, discloses an evaluation device that is capable of calculating a risk of an individual being identified in a system that anonymizes personal information and externally provides such information.

### SUMMARY

It is an object of the present disclosure to appropriately acquire consent to information collection from a provider of information.

An aspect of the present disclosure provides an information processing device including a control unit configured to: acquire first consent to use of first data collected from a first vehicle for a first purpose from a user of the first vehicle; acquire second consent to diverted use of the first data collected based on the first consent for a second purpose from the user of the first vehicle; and perform a predetermined process to give the user of the first vehicle a part of a profit generated through the diverted use of the first data for the second purpose.

Other aspects provide a method executed by the above device, a program for causing a computer to execute the method, and a computer-readable storage medium storing the program in a non-transitory manner.

According to the present disclosure, it is possible to appropriately acquire consent to information collection from a provider of information.

### BRIEF DESCRIPTION OF THE DRAWINGS

Features, advantages, and technical and industrial significance of exemplary

embodiments of the disclosure will be described below with reference to the accompanying drawings, in which like signs denote like elements, and wherein:

FIG. 1 is a schematic diagram of a vehicle system according to a first embodiment;

FIG. 2 is a diagram illustrating components of an in-vehicle device and a server device;

FIG. 3A is an example of data stored in an in-vehicle device and a server device;

FIG. 3B is an example of data stored in an in-vehicle device and a server device;

FIG. 3C is an example of data stored in an in-vehicle device and a server device;

FIG. 4 is a flowchart of processing executed by the in-vehicle device;

FIG. 5 is an exemplary window for querying consent to providing data; and

FIG. 6 is a diagram illustrating the contract-related information according to the second embodiments.

### DETAILED DESCRIPTION OF EMBODIMENTS

In recent years, attempts have been made to use data collected from automobiles. It is expected that various services can be provided by using data collected from vehicles as big data.

On the other hand, the data transmitted from the vehicle may include personal information and personal information. Such data may cause privacy problems by linking with individuals, such as location information, as well as personal information itself.

For this reason, an attempt is made to explain the use of the data to the user (for example, the owner or the driver of the vehicle), obtain the consent, and use the collected data. The provision of the explanation and the acquisition of the consent can be performed, for example, via an in-vehicle device mounted on the target vehicle.

On the other hand, there is a case where the data collected in the past is desired to be used for a purpose different from the initial purpose. In other words, it is a case where the collected data is diverted to the original purpose. In this way, if a condition not included in the original data provision contract is added later, it is preferable to obtain consent again to the user. However, in a conventional system, a data provision contract can be concluded with a user before data collection is started, but in a case where it is desired to divert the collected data to an initial purpose, it is not considered to obtain consent from the user again.

An information processing device according to the present disclosure solves such a problem.

An information processing device according to a first aspect of the present disclosure includes a control unit that executes: acquiring, from a user of the first vehicle, a first consent for using first data collected from the first vehicle for a first purpose; acquiring, from a user of the first vehicle, a second consent for converting the first data collected based on the first consent to a second purpose; and performing predetermined processing for giving a part of a profit generated by converting the first data to the second purpose to a user of the first vehicle.

The first data is data acquired while the first vehicle is traveling, and includes personal information of the driver and data related to the traveling of the first vehicle (for example, position information, speed information, and the like).

The control unit of the information processing device acquires, from the user, an agreement (first agreement) to use the first data collected from the first vehicle for the first purpose. Further, the control unit is configured to be able to additionally acquire, from the user, an agreement (second agreement) to divert the collected first data to the second purpose. At this time, the control unit performs predetermined processing for distributing the profit generated by converting the first data to the second purpose to the user. As the predetermined processing, for example, a process of giving an incentive for providing data to a user, a process of presenting the contents of the incentive to the user, and the like can be exemplified.

According to such a configuration, even when the purpose of use of the first data is changed ex post (that is, the first data is diverted), it is possible to obtain the consent to the data provision from the user. Further, by performing a process related to the distribution of profits, the user can be motivated to agree to divert data.

The information processing device may calculate an incentive to be given to the user on the basis of an assumed profit as a predetermined process. Further, the content of the calculated incentive may be presented to the user.

Further, the information processing device may acquire the first consent and the second consent at the same timing. For example, the information processing device may acquire, from the user, consent regarding “handling of the first data in a case where the use condition of the first data is changed ex post facto”.

For example, a confirmation may be made to the user, such as “whether to agree in advance to use the first data under the changed condition when the use condition is changed”. In this case, the content of the incentive given after the use condition is changed may be presented to the user.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

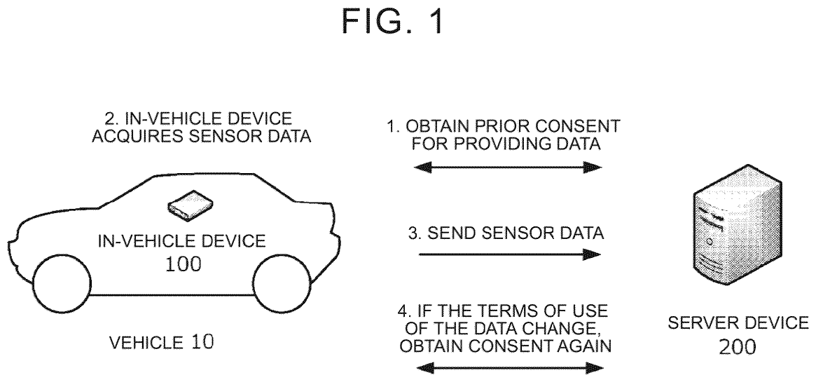

An outline of a vehicle system according to a first embodiment will be described with reference to FIG. 1. The vehicle system according to the present embodiment includes the vehicle 10 on which the in-vehicle device 100 is mounted and the server device 200. A plurality of vehicles 10 (in-vehicle devices 100) may be included in the system.

The vehicle 10 is a probe vehicle for collecting data. The vehicle 10 is configured to be able to collect data related to traveling and data related to an occupant, and can transmit the collected data to the server device 200 via the in-vehicle device 100. Examples of the traveling data include vehicle speed, traveling direction, position information, information on driving operation, information on vehicle behavior, and image data captured by an in-vehicle camera. Further, as the data related to the occupant, for example, an identifier, a gender, an age, or the like of an individual can be exemplified. In the following description, the data collected by the vehicle 10 is referred to as sensor data. Although the sensor data is an example of “first data”, the data collected by the vehicle 10 is not necessarily obtained by sensing.

The server device 200 is a device that provides a predetermined service based on sensor data collected from the vehicle 10. For example, by collecting position information and speed information from a plurality of vehicles 10, traffic information and traffic information can be generated and provided to other vehicles. In addition, by collecting data related to the occupant of the vehicle, it is possible to provide information suitable for an individual. In addition, it is possible to generate road map data by collecting images captured by the in-vehicle camera.

The server device 200 may be a device that provides a service to the vehicle 10 (or another vehicle) based on sensor data collected from the vehicle 10, or may be a device 10 that relays sensor data collected from the vehicle 10 to a further external device. For example, when there is a plurality of types of sensor data collected from the vehicle 10, the server device 200 may relay the sensor data to different external devices under the management of different operators for each type of sensor data.

The server device 200 obtains, from a user (e.g., driver) associated with the vehicle 10, an agreement to provide sensor data (i.e., to transmit the sensor data to the server device 200).

The server device 200 acquires consent at a timing when it is necessary to use the sensor data, and requests the in-vehicle device 100 to transmit the sensor data on condition that the consent is obtained.
Further, the server device 200 is configured to have a function of acquiring consent again from the user of the vehicle 10 when a change in the use condition occurs with respect to the sensor data collected in the past. The use condition is a condition when the business operator using the sensor data uses the sensor data.

In the vehicle system according to the present embodiment, the plurality of in-vehicle devices 100 and the server device 200 are connected to each other via a network. The network may be, for example, a Wide Area Network (WAN) that is a global public communication network such as the Internet, or another communication network. The network may also include telephone communication networks for cellular phones and the like, and wireless communication networks such as Wi-Fi (registered trademark).

Each element of the system will be described.

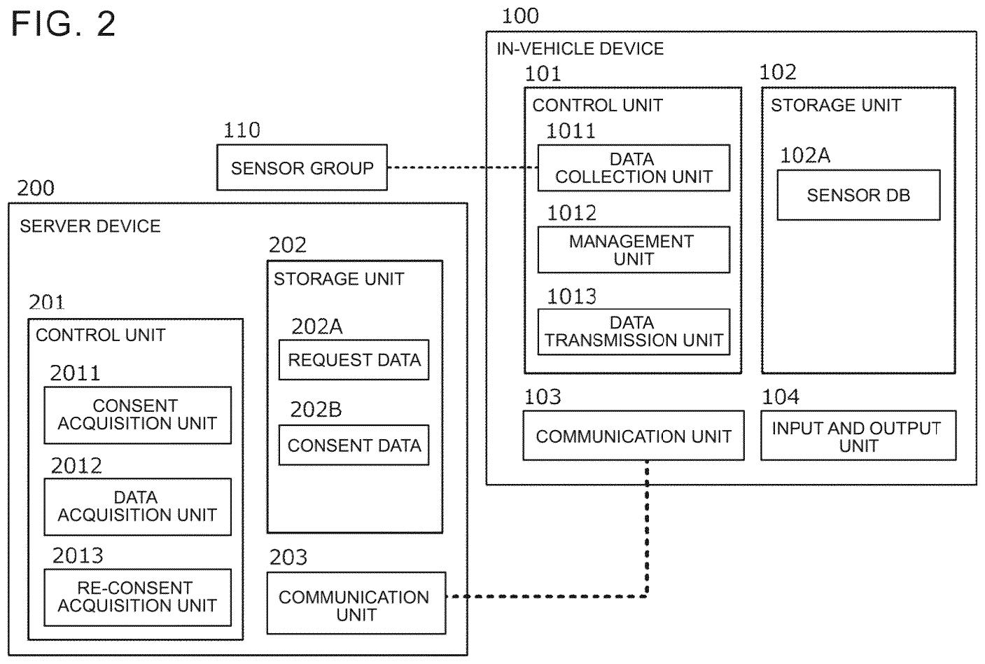

FIG. 2 is a diagram illustrating a system configuration of the in-vehicle device 100 and the server device 200.

First, a configuration of the server device 200 will be described.

The server device 200 can be configured as a computer having a processor such as a CPU or a GPU, a main storage device such as a Random Access Memory (RAM) or a Read Only Memory (ROM), and a secondary storage device such as a EPROM, a hard disk drive, or a removable medium. Operating System (OS), various programs, various tables, and the like are stored in the secondary storage device, and the programs stored therein are executed to realize respective functions that meet predetermined objectives, as will be described later. However, some or all of the functions may be implemented by a hardware circuit such as an ASIC or an FPGA. Note that the server device 200 may be configured by a single computer or may be configured by a plurality of computers that cooperate with each other.

The server device 200 includes a control unit 201, a storage unit 202, and a communication unit 203.

The control unit 201 is an arithmetic device that governs the control performed by the server device 200. The control unit 201 can be realized by an arithmetic processing device such as a CPU.

The control unit 201 includes three functional modules: a consent acquisition unit 2011, a data acquisition unit 2012, and a re-consent acquisition unit 2013. The function modules may each be implemented by executing programs, stored in the auxiliary storage unit, on the CPU.

Prior to the acquisition of the sensor data from the vehicle 10, the consent acquisition unit 2011 acquires the consent to the data provision from the user of the vehicle 10.

The server device 200 transmits data (hereinafter, contract-related data) for concluding a data provision contract to the in-vehicle device 100.
The contract-related data includes information identifying the target sensor data, an acquisition condition of the sensor data, and information regarding a provision condition of the sensor data. The provision condition includes, for example, an operator who uses the sensor data, the purpose of use of the sensor data, and the contents of the incentive given to the user.
The consent acquisition unit 2011 presents “what kind of sensor data is provided under what kind of conditions” to the user of the vehicle 10 via the in-vehicle device 100, and acquires an answer.

Based on the response from the user of the vehicle 10, the consent acquisition unit 2011 determines whether or not there is a consent to the data provision for each type of sensor data. In addition, the consent acquisition unit 2011 records the presence or absence of the consent when the consent to provide the sensor data of the specific type is obtained. When there is a plurality of sensor data to be provided, or when there are a plurality of operators using the sensor data, a comprehensive consent may be obtained, or a plurality of consents may be obtained.

It is to be noted that the user of the vehicle 10 agrees to provide the data, and thus it can be regarded that a data provision contract is established between the user and the operator who receives the provision of the sensor data.

In addition, the consent acquisition unit 2011 is configured to be capable of executing a process related to an incentive provided to the user as a consideration for providing data. The incentive provided to the user may be calculated based on, for example, a profit (or an expected profit) generated by the operator using the sensor data.

The process related to the incentive may be, for example, a process of presenting the contents of the incentive to the user, or a process of granting the incentive (for example, to the user's account).

The data acquisition unit 2012 requests each of the plurality of vehicles 10 (the in-vehicle device 100) to transmit the sensor data. For example, when the server device 200 executes a service for generating road map data based on an image captured by the vehicle 10, the server device 200 requests the vehicle 10 to transmit the image data. The type of sensor data requested by the server device 200 may vary depending on the service executed by the server device 200. In addition, the data acquisition unit 2012 receives sensor data from the plurality of vehicles 10 (in-vehicle devices 100) and stores the sensor data in the storage unit 202. The stored sensor data is used to provide a predetermined service.

The re-consent acquisition unit 2013 executes a process of acquiring the consent again from the user of the vehicle 10 with respect to the use of the sensor data collected by the server device 200 in the past.

For example, consider a case where a business operator receives the provision of an image of an in-vehicle camera under a condition of “use for generating a map” in the past. In this case, the provided image cannot be used for purposes other than map generation. If it is desired to use the sensor data outside the conditions, the user of the vehicle 10 must obtain the consent again. In such a case, the re-consent acquisition unit 2013 executes a process of acquiring the consent again from the corresponding user. A specific example will be described later.
Note that, in a case where the user gains consent again due to a change in the usage conditions of the data, the incentive may vary depending on the conditions.

The storage unit 202 includes a main storage device and an auxiliary storage device. The main storage device is a memory in which a program executed by the control unit 201 and data used by the control program are expanded. The auxiliary storage device is a device in which a program executed by the control unit 201 and data used by the control program are stored. The storage unit 202 stores sensor data collected from the vehicle 10.

Further, the above-described contract-related data is stored in the storage unit 202.

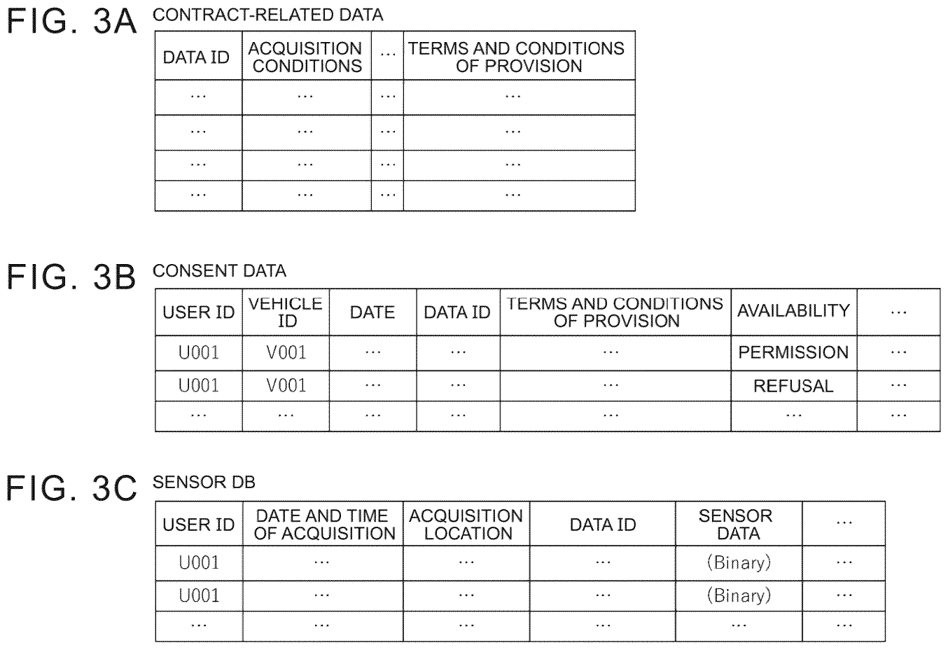

FIG. 3A illustrates an exemplary contract-related-data 202A.
The contract-related data is data for concluding a data provision contract with a user of the vehicle 10, and includes information on an identifier (data ID) of the sensor data, an acquisition condition of the sensor data, a provision condition of the sensor data, and the like. Examples of the sensor data acquisition condition include “an image is captured at a specific point”, “a moving image is captured in a specific section”, and “position information is acquired every second in a specific time zone”.

In addition, the storage unit 202 stores data (hereinafter referred to as consent data) for managing the user's consent to the provision of the sensor data.

Here, the consent data will be described. The consent data is data for recording whether or not the acquisition and use of the sensor data is permitted by the user. The consent data may be generated, for example, based on a result of an interaction with the driver.

FIG. 3B illustrates an exemplary consent-data 202B.

As illustrated, the consent data includes fields of user ID, vehicle ID, date, data ID, provision criteria, and availability. The user ID field is stored with an identifier that uniquely identifies a user who has agreed to provide data. In the vehicle ID field, an identifier of the vehicle on which the in-vehicle device 100 on which the user has operated the consent is mounted is stored. The date field stores the date of the consent. In the data ID field, information for identifying sensor data is stored. In the provision condition field, information on the condition of the data provision contract is stored. In the provision availability field, the presence or absence of consent (“permission” or “rejection”) regarding the provision of the sensor data is stored.

The communication unit 203 is a communication interface for connecting the server device 200 to a network. The communication unit 203 includes, for example, a network interface board and a wireless communication circuit for wireless communication.

Next, the in-vehicle device 100 will be described.

The vehicle 10 is a connected car having a function of communicating with an external network. The vehicle 10 is equipped with an in-vehicle device 100.

The in-vehicle device 100 is a computer for collecting information. In the present embodiment, the in-vehicle device 100 includes a plurality of sensors for collecting information related to traveling of the vehicle 10, and transmits the collected sensor data to the server device 200 at a predetermined timing. The in-vehicle device 100 may be a device (for example, a car navigation device or the like) that provides information to an occupant of the vehicle 10, or may be an Electronic Control Unit (ECU) of the vehicle 10. The in-vehicle device 100 may be a Data Communication Module (DCM) having a communication function.

The in-vehicle device 100 can be configured as a computer including a processor such as a CPU and a GPU, a main storage device such as a RAM and a ROM, and an auxiliary storage device such as a EPROM, a hard disk drive, and a removable medium. The secondary storage device stores a OS, various programs, various tables, and the like, and by executing the programs stored therein, it is possible to realize various functions that meet predetermined objectives, as will be described later. However, some or all of the functions may be implemented by a hardware circuit such as an ASIC or an FPGA.

The in-vehicle device 100 includes a control unit 101, a storage unit 102, a communication unit 103, and an input/output unit 104. The in-vehicle device 100 is connected to the sensor group 110.

The control unit 101 is an arithmetic unit that realizes various functions of the in-vehicle device 100 by executing a predetermined program. The control unit 101 may be implemented by, for example, a CPU.

The control unit 101 includes a data collection unit 1011, a management unit 1012, and a data transmission unit 1013 as functional modules. Each functional module may be implemented by execution of a stored program by the CPU.

The data collection unit 1011 acquires sensor data from one or more sensors included in the sensor group 110 at predetermined timings, and stores the sensor data in the sensor DB102A of the storage unit 102. When a plurality of pieces of sensor data can be acquired, the data collection unit 1011 may acquire all of the sensor data. The sensor DB 102A is a data base in which sensor data collected from sensors included in the vehicles 10 is stored.

FIG. 3C is a diagram illustrating an example of data stored in the sensor DB 102A. The sensor DB102A stores, in addition to the sensor data, an identifier of the user, a date and time when the sensor data is acquired, a location (position data) where the sensor data is acquired, and a ID of the sensor data.

The management unit 1012 performs a process of transmitting sensor data stored in the sensor DB102A to the server device 200. Specifically, the management unit 1012 executes the following processing.
(1) Process of obtaining consent to providing sensor data
   The management unit 1012 acquires, from the user, the presence or absence of the consent to provide the sensor data based on the contract-related data transmitted from the server device 200, and responds to the server device 200.
(2) Processing for receiving a data transmission request from the server device 200
   Upon agreeing to provide the specific sensor data, a data transmission request is transmitted from the server device 200 to the in-vehicle device 100.
   The data transmission request is data for requesting the vehicle 10 to transmit specific sensor data. For example, the data transmission-request includes an identifier (data ID) of the sensor data.
(3) Process of identifying data to be transmitted to the server device 200
   The management unit 1012 determines whether or not the own device possesses the sensor data requested by the server device 200, and identifies the sensor data as data to be transmitted to the server device 200 when the own device possesses the sensor data.
   The management unit 1012 recognizes which type of sensor data is requested by referring to the data ID included in the data transmitting request. In addition, the management unit 1012 refers to the sensor DB102A and determines whether the in-vehicle device 100 has sensor data that is requested by the server device 200 and for which an agreement on provision has been obtained.

When the in-vehicle device 100 holds the sensor data requested by the server device 200, the management unit 1012 determines the sensor data as a transmission target.

The data transmission unit 1013 acquires the sensor data determined by the management unit 1012 from the storage unit 102 and transmits the sensor data to the server device 200.

The storage unit 102 is a memory device including a main storage device and an auxiliary storage device. An operating system (OS), various programs, various tables, and the like are stored in the auxiliary storage device. The programs stored in the auxiliary storage device are loaded into the work area of the main storage device and executed, and through this execution, various functions can be implemented that match the predetermined purpose, which will be described later.

The main storage device may include a RAM and a ROM. The secondary storage device may include a EPROM or a hard disk drive (HDD, Hard Disk Drive). Further, the auxiliary storage device may include a removable medium, that is, a portable recording medium.

The communication unit 103 is a wireless communication interface for connecting the in-vehicle device 100 to a network. The communication unit 103 is configured to be able to communicate with the server device 200 according to a communication standard such as a mobile communication network or a radio LAN, Bluetooth (registered trademark).

The input/output unit 104 is a unit that receives an input operation performed by a user of the apparatus and presents information. In the present embodiment, the input/output unit 104 includes one touch panel display. That is, the apparatus includes a liquid crystal display, a control unit thereof, a touch panel, and a control unit thereof.

The sensor group 110 is a set of a plurality of sensors included in the vehicle 10. The plurality of sensors may obtain data regarding travel of the vehicle, such as, for example, velocity sensors, accelerometers, and GPS modules. Further, the plurality of sensors may acquire data related to the traveling environment of the vehicle 10, such as an image sensor, an illuminance sensor, and a rainfall sensor.

The sensor group 110 may include a sensor for collecting data related to a driver or an occupant of the vehicle 10. For example, an occupant of the vehicle may be identified based on an image obtained by capturing an inside of the vehicle, and data related to the occupant may be transmitted as sensor data.

In addition, the sensor group 110 may include an in-vehicle camera mounted to face the outside of the vehicle. The image acquired by the in-vehicle camera can also be regarded as one of the sensor data.

The configuration shown in FIG. 2 is an example, and all or a part of the functions shown in FIG. 2 may be executed using a specially designed circuit. Further, a program may be stored or executed by a combination of the main storage device and the auxiliary storage device other than the functions shown in FIG. 2.

Next, details of processing executed by the server device 200 will be described.

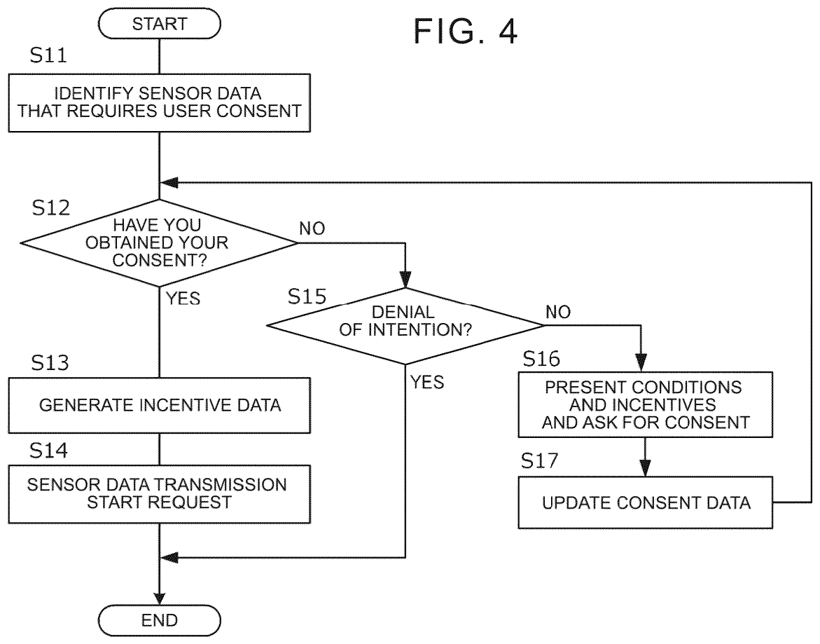

When specific sensor data is required, the server device 200 transmits contract-related data to the in-vehicle device 100 and requests the provision of the sensor data.
FIG. 4 is a flowchart of processing in which the server device 200 requests the in-vehicle device 100 to provide sensor data.

First, in S11, the consent acquisition unit 2011 specifies sensor data that requires acquisition of consent from the user.

Next, in S12, the consent acquisition unit 2011 determines whether or not the consent of the user of the vehicle 10 has been obtained with respect to the acquisition and use of the target sensor data. For example, if there is a record in the consent data 202B that matches the data ID indicated in the contract-related data, and there is a record in which the provision availability field is “permitted”, this step is an affirmative determination. In this step, a negative determination is made when the provision availability field is “rejected” or when the corresponding record does not exist (when the user does not make an intention indication about the target sensor data).

If an affirmative determination is made on S12, the process proceeds to S13. In S13, an incentive given to a user is determined as a consideration for providing sensor data, and data (incentive data) for giving the incentive is generated. The incentive may be, for example, a point or electronic money. In this case, the incentive data may be data issued to a point or a device that manages electronic money.

In S14, the data acquisition unit 2012 transmits a data transmission request to the in-vehicle device 100, and requests that the corresponding sensor data be started to be transmitted. In response to the request, the in-vehicle device 100 (management unit 1012) starts transmission of the corresponding sensor data.

If a negative determination is made on S12, the process proceeds to S15. In S15, the consent acquisition unit 2011 determines whether or not the user of the vehicle 10 has previously indicated his/her intention to reject the transmission of the sensor data having the corresponding data ID. For example, if there is a record in the consent data 202B that matches the data ID indicated in the contract-related data, and there is a record in which the permission field is “denied”, this step is an affirmative determination. When an affirmative determination is made in S15, the sensor data is not requested to be transmitted.

When a negative determination is made in S15, this means that the user of the vehicle 10 has not previously indicated his/her intention to provide the data. In this case, the process transitions to S16, and the server device 200 transmits the contract-related data to the in-vehicle device 100 and inquires of the user of the vehicle 10 whether or not there is an agreement.

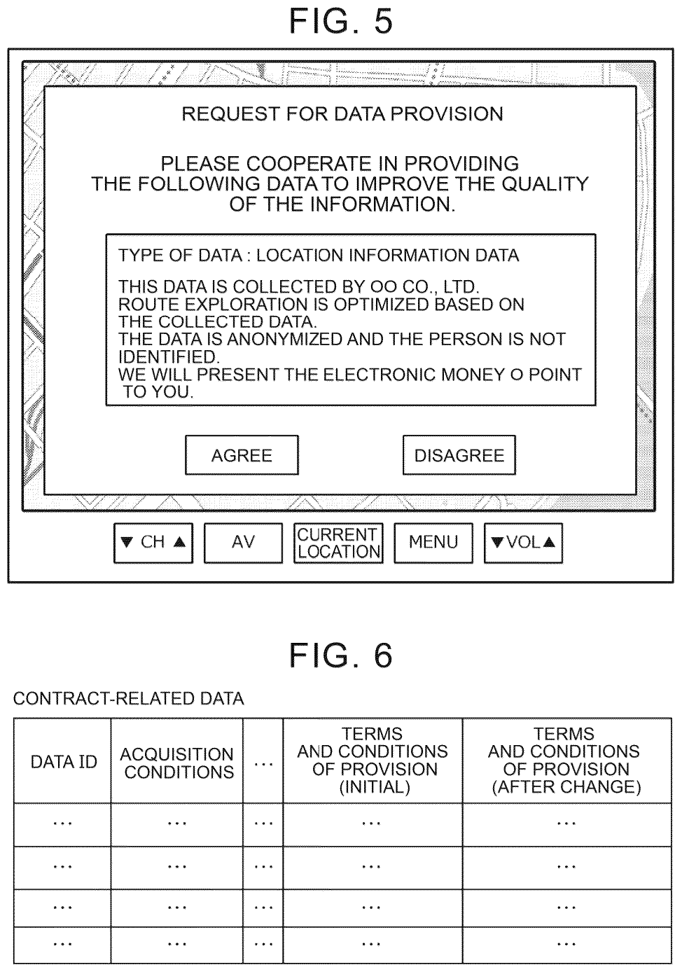

Upon receiving the contract-related data from the server device 200, the in-vehicle device 100 confirms with the user whether or not the corresponding type of sensor data may be provided via the input/output unit 104. For example, the confirmation can be performed via a screen as shown in FIG. 5. The screen may include a type of sensor data, an application, a transmission destination, an acquisition condition, information on a business operator using the sensor data, and the like.

In addition, the in-vehicle device 100 may acquire the presence or absence of the consent after giving guidance on the conditions of the data provision contract and the incentives given in accordance therewith.
In a case where there is a plurality of types of sensor data to be transmitted, the consent may be obtained on a plurality of screens, or the user may be allowed to select whether or not to agree to provide the sensor data on the same screen.

When the user of the vehicle 10 makes an answer, S17 notifies the server device 200 of the answer of the user via the in-vehicle device 100, and the answer is reflected in the consent-data 202B. Based on the content, the process from S12 is repeated.

Through the processing described above, the server device 200 can acquire the consent to providing the sensor data from the user of the vehicle 10 via the in-vehicle device 100, and start the collection of the sensor data.

On the other hand, even when the user of the vehicle 10 agrees to provide the specific sensor data, the usage conditions and the like of the data may be changed ex post facto. For example, when an image of an in-vehicle camera is acquired for the purpose of “generating a road map”, the acquired image cannot be used for any purpose other than the purpose. In this way, if the purpose of use of the data changes, a new consent must be obtained from the user of the vehicle 10.

In such a case, the server device 200 executes a process of requesting the in-vehicle device 100 to agree again.

In such a case, the server device 200 (re-consent acquisition unit 2013) performs the same processing as the processing illustrated in FIG. 4, and acquires consent again from the user of the vehicle 10.

At this time, the re-consent acquisition unit 2013 acquires the changed contract conditions and the information on the corresponding incentive, and updates the contract-related data. Further, in S16, the updated contract-related data is transmitted to the in-vehicle device 100. In S16, the in-vehicle device 100 may present the changed contract conditions and the incentives given to the user when the contract conditions are accepted. If the user agrees, S13 may generate incentive data for giving a corresponding incentive. Further, the re-consent acquisition unit 2013 may add an entry corresponding to the re-consent to the consent-data 202B in order to record the changed usage terms.
Note that when the usage conditions of the sensor data are changed, S14 process is not executed.

As described above, the server device 200 according to the first embodiment acquires the consent to use the sensor data for a predetermined purpose from the user via the in-vehicle device 100. In addition, when it is necessary to acquire consent again for the collected sensor data, the server device 200 additionally acquires consent from the user. This makes it possible to further utilize the collected sensor data.

### Modification of First Embodiment

In the first embodiment, the server device 200 acquires the consent from the user of the vehicle 10 via the in-vehicle device 100. On the other hand, the server device 200 may acquire the consent from the target user by using a data source other than this. For example, when data for specifying a contact address, a mail address, a mobile terminal, or the like of the target user is available, the target user may be contacted using the data. In addition, in a case where there is a platform that manages the consent to the data provision separately from the server device 200, the contact address of the target user may be acquired using the platform.

### Second Embodiment

In the first embodiment, the server device 200 acquires the consent from the user each time at the timing when the sensor data is required.
On the other hand, in a case where a change in the use condition is expected after the fact, it is preferable to form an agreement on “handling of sensor data in a case where a condition change occurs” when the data provision contract is concluded for the first time.

In the second embodiment, when concluding the data provision contract, two of “a range of conditions capable of maintaining consent to data provision” and “corresponding incentive” are specified, and an answer is obtained from the user. In other words, the second embodiment is an embodiment in which, in the first embodiment, the consent obtained in two times before and after the use condition of the sensor data is changed is acquired simultaneously in advance.

In the second embodiment, when the use condition of the data is changed, the server device 200 determines whether or not the data can be used based on the answer obtained in advance.

FIG. 6 is an example of contract-related data used in the second embodiment. As illustrated, in the second embodiment, two types of fields related to the provision condition of the sensor data are provided in the contract-related data. As a result, it is possible to present the user with two of the initial provision condition and the changed provision condition, and obtain the consent.

This makes it possible, for example, to clarify the conditions under which data can be provided, such as “at the present time, a contract is made with the usage conditions A and the incentive B” and “in the future, if the usage conditions are changed to A1, the incentive is raised to B1 instead of maintaining the consent”. When a change in the condition actually occurs, the use of the data can be continued on the basis of the response of the user acquired at the time of the initial contract conclusion.

### Modification

The above-described embodiments are merely examples, and the present disclosure may be appropriately modified and implemented without departing from the scope thereof.
For example, the processes and means described in the present disclosure can be freely combined and implemented as long as no technical contradiction occurs.

Further, in the description of the embodiment, the face image is exemplified as information for identifying the user of the vehicle 10, but the user of the vehicle 10 may identify the face image based on other biometric information. Examples of such biological information include a fingerprint, a voice print, and an iris pattern.

Further, in the description of the embodiment, only the server device 200 is illustrated as the transmission destination of the sensor data, but there may be a plurality of transmission destinations of the sensor data. In this case, contract-related data may be received from each of the plurality of external devices. The transmission destination of the sensor data may be a manufacturer of the vehicle 10 or a related business operator, or may be a third party that has concluded a data provision contract.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc (CD)-read-only memory (ROM), digital versatile disc (DVD), Blu-ray disc, etc.), a ROM, a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device comprising a control unit configured to:
acquire first consent to use of first data collected from a first vehicle for a first purpose from a user of the first vehicle;
acquire second consent to diverted use of the first data collected based on the first consent for a second purpose from the user of the first vehicle; and
perform a predetermined process to give the user of the first vehicle a part of a profit generated through the diverted use of the first data for the second purpose.

2. The information processing device according to claim 1, wherein the predetermined process includes calculating an incentive to be given to the user based on an expected profit.

3. The information processing device according to claim 2, wherein the predetermined process includes presenting the calculated incentive to the user.

4. The information processing device according to claim 2, wherein the control unit acquires the first consent and the second consent at the same timing.

5. The information processing device according to claim 4, wherein the control unit presents, at the timing, the incentive to be given when the first data are converted to use for the second purpose to the user.
